(19) United States
(12) Patent Application Publication
(10) Pub. No.: US 2008/0236850 A1
(43) Pub. Date: Oct. 2, 2008

(54) Lift and float assist system for tractor three-point-hitches

(76) Inventor: E. Gerry Hawkes, Woodstock, VT (US)

Correspondence Address: E. Gerry Hawkes, 796 Wayside Road Ext., Woodstock, VT, 05091, US

(21) Appl. No.: 12/079,332

(22) Filed: Mar. 25, 2008

Related U.S. Application Data
(60) Provisional application No. 60/920,110, filed on Mar. 26, 2007.

(51) Int. Cl. A01B 59/043

(52) U.S. Cl. 172/448

(57) ABSTRACT

Vertically mounted compression springs inside heavy walled containment tubes with adjustable tensioning rods mounted above the three-point-hitch of a tractor and connected to the three-point-hitch implement lift arms by chains, which provide supplemental lifting, floating, height control and impact absorption for heavy, tractor-mounted implements.

### RELATED APPLICATIONS

The present application is a continuation-in-part application of U.S. provisional patent application, Ser. No. 60/920,110, filed Mar. 26, 2007, for LIFT AND FLOAT ASSIST SYSTEM FOR TRACTOR THREE-POINT-HITCHES, by E. Gerry Hawkes, included by reference herein and for which benefit of the priority date is hereby claimed.

### FIELD OF THE INVENTION

The present invention relates to agricultural, construction and industrial tractors and, more particularly, to their lift mechanisms that attach to implements.

### BACKGROUND OF THE INVENTION

The main problem with conventional hydraulic lift systems are that they raise and lower implements or tractor attachments, but when in the float mode the full weight of the implement drags over the ground unless the attachment is fitted with a wheel or wheels or unless the tractor is specially equipped at the factory with a hydraulic draft control system. However wheels can easily be damaged in some applications and can hinder proper implement function. Draft control only functions when the tractor is moving forward, can be inconsistent in maintaining a uniform height and is not found on many tractors. Another problem with conventional hydraulic lift systems are that even when the implements are fitted with wheels or when moving in reverse with a hydraulic draft control, a heavy implement can impact severely with obstacles such as rocks and stumps since it is too heavy to float or rise up on impact. Additional problems with hydraulic lift systems are that maintaining a heavy implement in a slightly raised position can stress and overheat the hydraulic system while robbing the tractor of power. Also when an implement is maintained in a slightly raised position by the lift hydraulics, it will not float or follow the contours of the ground. A further problem with conventional hydraulic lift systems is that much tractor power is lost if a heavy implement is dragged rather than floated over the ground. In addition an implement with its full weight dragging on the ground or riding on its own wheels does not transfer its weight to the rear driving wheels of the tractor, thus significantly reducing traction and increasing tire wear due to increased wheel spinning. Lastly a problem with conventional hydraulic lift systems not being able to float a heavy implement is that attempting to turn with a heavy implement dragging behind is difficult.

A primary object of the present invention is to provide a lift and float assist system for tractor three-point-hitches to facilitate the lifting and floating of heavy implements attached to tractor three-point-hitches.

An object is to provide a lift and float assist system for tractor three-point-hitches that assists in the lifting of heavy implements attached to tractor three-point-hitches.

Another object is to provide a lift and float assist system for tractor three-point-hitches that allows a heavy implement to float lightly over the contours of the ground.

Another object is to provide a lift and float assist system for tractor three-point-hitches that reduces damage to tractors and implements by making it much easier for the implement to rise and clear obstructions upon first impact.

Another object is to provide a lift and float assist system for tractor three-point-hitches that reduces or eliminates the constant pumping and overheating of hydraulic systems when an implement is held slightly off the ground by a tractor three-point-hitch.

Another object is to provide a lift and float assist system for tractor three-point-hitches that reduces or eliminates the loss of tractor power when an implement is held slightly off the ground by a tractor three-point-hitch.

Another object of this invention is to provide a lift and float assist system for tractor three-point-hitches that reduces operator fatigue by eliminating the need to constantly monitor and adjust three-point-hitch height to maintain implement position just off or light on the ground when working on variable terrain.

Another object is to provide a lift and float assist system for tractor three-point-hitches that reduces implement drag or pulling resistance on the ground, thus allowing the same amount of work to be accomplished with a much smaller tractor.

Another object is to provide a device that maintains light implement pressure on the ground, thus reducing implement side resistance to turning.

Another object is to provide a device that transfers much of the weight of the implement to the rear driving wheels of the tractor, thus significantly improving traction and reducing tire wear due to wheel slippage and spinning.

Another object is to provide a device that maintains light implement pressure on the ground, thus reducing twisting stress on the three-point-hitch as the implement swings through a turn.

Another object is to provide a device that maintains light implement pressure on the ground, thus reducing ground disturbance as the implement swings through a turn.

### SUMMARY OF THE INVENTION

In accordance with the present invention, there are provided vertically mounted compression springs inside heavy walled containment tubes with adjustable tensioning rods mounted above the three-point-hitch of a tractor and connected to the three-point-hitch lift arms by chains. The heavy, compression springs are similar to those found on car or pickup truck suspension systems. The heavy, adjustable tensioning rod, usually an inch or more in diameter, runs the entire length of the compression spring and extends beyond each end where it can be tensioned by threaded nuts and washers. The heavy, outer tube which contains the compression spring and tensioning rod, keeps the spring and rod straight and protects them from damage as well as serves as a safety guard for people's hands and fingers. The removable cap at the top of the containment tube prevents debris and water entry as well as serving as a safety guard. The funnel shaped bottom on the containment tube retains the compression spring's downward movement and aligns the tensioning rod in the center of the tube. The heavy mounting bar or angle beam attached to the tractor directly above the three-point-hitch serves as a mounting for the lift assist and float system components. Threaded nuts located at each end of the tensioning rod allow adjustment of the lift assist force as well as both the float and lift heights. The lift chains flexibly connect between the lower end of the tensioning rods and the three-point-hitch lift arms, thus transferring lift force from the compression springs to the lift arms.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a rear plan view of a lift and float assist system attached to the lift arms of a three-point-hitch; and

FIG. 2 is a side view of a lift and float assist system attached to a lift arm of a three-point-hitch.

For purposes of clarity and brevity, like elements and components will bear the same designations and numbering throughout the Figures.

### DESCRIPTION OF THE PREFERRED EMBODIMENT

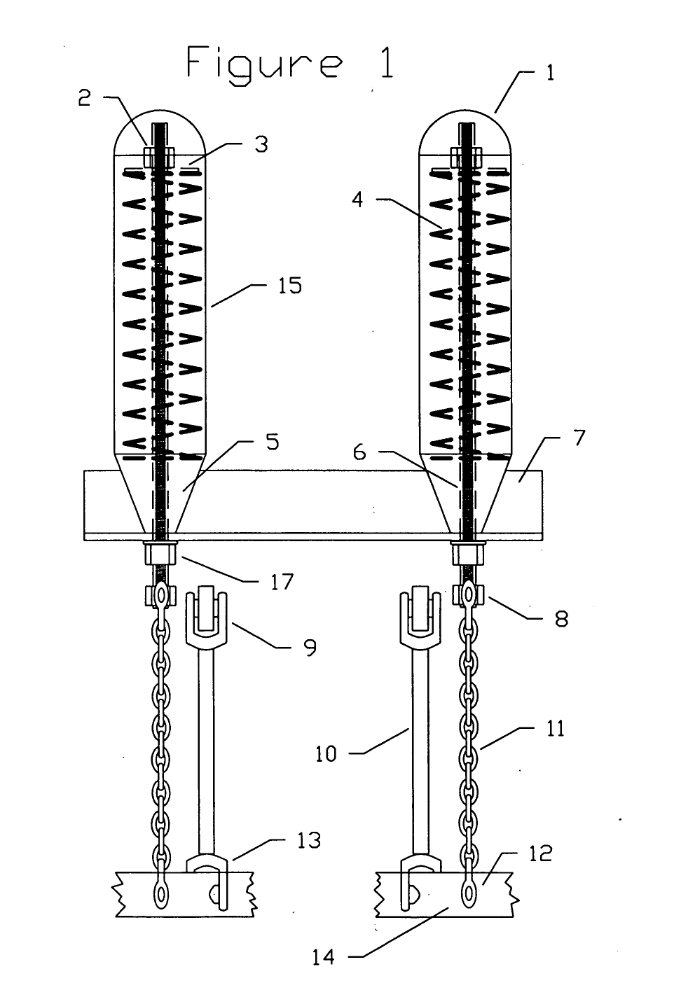

FIG. 1 is a rear plan view of a lift and float assist system attached to the lift arms of a three-point-hitch.

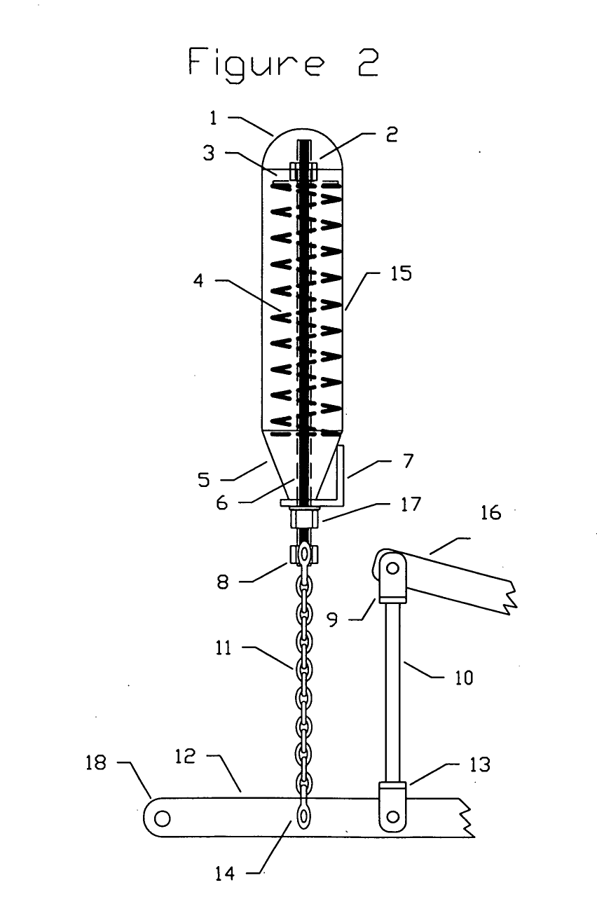

FIG. 2 is a side view of a lift and float assist system attached to a lift arm of a three-point-hitch.

In addition to the description of the invention below, the following are components of a standard tractor three-point-hitch and are shown in the two Figures:
hydraulic lift arm 16
upper lift rod linkage 9
lift rod 10
lower lift rod linkage 13
implement lift arm 12
implement attachment point 18

The two figures illustrate a lift and float assist system for tractor three-point-hitches, which are typically comprised of a pair of vertically mounted compression springs 4 inside heavy walled containment tubes 15 with adjustable tensioning rods 6 mounted above the three-point-hitch of a tractor and connected to the three-point-hitch implement lift arms 12 by lift chains 11. The heavy, compression spring 4 is similar to those found on car or pickup truck suspension systems. The heavy, threaded tensioning rod 6, usually an inch or more in diameter, runs the entire length of the compression spring 4 and extends beyond each end where it can be tensioned by nuts and washers. The heavy, containment tube 15 which contains the compression spring 4 and tensioning rod 6, keeps them straight and protects them from damage as well as serves as a safety guard for people's hands and fingers. The removable tube cap 1, at the top of the containment tube 15 prevents debris and water entry as well as serves as a safety guard for people's hands and fingers. The tube bottom 5 on the containment tube 15 retains the compression spring's 4 downward movement and aligns the tensioning rod 6 in the center of the tube. The heavy mounting bar 7 or angle beam, attached to the tractor directly above the three-point-hitch, serves as a mounting for the lift and float assist system components. Threaded nuts 2 & 17, located at each end of the tensioning rod 6, allow adjustment of the lift assist force as well as both the float and lift heights. The lift chain 11 flexibly connects between the lower end of the tensioning rod 6 and the three-point-hitch's implement lift arm 12, thus transferring lift force from the compression spring 4 to the implement lift arm 12.

The heavy compression spring 4 is preferably a coil type compression spring 4 similar to that found in the suspension of cars and the front suspension of pickup trucks. A similar function could be achieved by using a compressed air suspension or an elastomer shock absorber type spring.

The tensioning rod 6 is preferably an Acme threaded rod, generally 1″ or larger in diameter, and extending completely through the middle of the spring, beyond the spring ends and lower mounting bar 7 so that the compression spring 4 may be tensioned by tightening the upper tensioning nut 2 and/or the lower tensioning nut 17. The tensioning rod 6 could also be a bar or rod with a series of progressive holes where pins could be inserted to select various tensions.

The containment tube 15 is preferably heavy walled steel pipe, slightly larger in internal diameter than the external diameter of the compression spring 4 and slightly longer than the length of the compression spring 4. The containment tube 15 can be made of any material strong enough to contain the compression spring 4.

The tube cap 1 fits onto the upper containment tube 15 end to prevent the entry of debris and water as well as to prevent accidental contact of compression spring 4 and tensioning rod 6 components with hands and fingers. The tube cap 1 may be made of any material that is of suitable strength and may fit into, onto or over the upper end of the containment tube 15.

The tube bottom 5 is preferably a tapered steel cone which retains the bottom of the compression spring 4 and aligns the tensioning rod 6. The tube bottom 5 must be strong enough to support the containment tube 15 above and the downward force of the compression spring 4 when it is under maximum pressure. The tube bottom 5 is helpful in aligning the tensioning rod 6, but it is not critical, thus the tube bottom 5 may be replaced with a flat bottom and central hole. The tube bottom 5 can be made from any material that is strong enough to support the containment tube 15 and compression spring 4 when under full load.

The mounting bar 7 is preferably steel and serves as a mounting for the containment tubes 15 with their funnel bottoms 5 and the associated parts as well as providing the attachment to a tractor. A heavy length of steel angle works well for its strength and ease of mounting the containment tubes 15 and funnel bottoms 5 as well as the ease to which it can be mounted to a tractor. However the mounting bar 7 can be made of other rigid and strong materials and can take the form of a square or rectangular tube, solid bar or U-channel.

The lower tensioning nut 17 and the upper tensioning nut 2 with its associated retention washer 3 are threaded up and down the tensioning rod 6 to adjust lift force as well as float height and lift height. Threading the upper tensioning nut 2 down or the lower tensioning nut 17 up increases the lift force by increasing the tension in the compression spring 4. If both the upper tensioning nut 2 and the lower tensioning nut 17 are threaded down equally, compression spring 4 tension and lift force remains unchanged, but the float and lift heights are increased. Conversely, threading the upper tensioning nut 2 up and the lower tensioning nut 17 up equally does not change the compression spring 4 tension or lift force, but does lower the float and lift heights. The threaded nuts 2 & 17 are preferably steel, but can be made of any material which can withstand the forces applied.

The lift chain 11 flexibly-connects the lower end of the tensioning rod 6 to the three-point-hitch implement lift arm 12 thus transferring the lift force provided by the tension on the compression spring 4 to the implement lift arm 12. The flexibility of the lift chain 11 accommodates changes in alignment as the three-point-hitch implement lift arm 12 moves up and down and as different sized implements are attached. The upper end of each lift chain 11 is preferably attached to the lower end of each tensioning rod 6 with an adjustable shackle 8 which may be comprised of a shackle welded to a threaded nut which is in turn threaded onto the lower end of the tensioning rod 6. The lower end of each lift chain 11 is preferably attached to each three-point-hitch implement lift arm 12 with a lower shackle 14 pinned through a mounting hole in the implement lift arm 12. Lift chains 11 may be replaced by any other flexible connection of suitable strength such as cables or rods with pivot joints at each end.

The mounting bar 7 supports and is attached to each containment tube 15 and its associated tube bottom 5. In most cases the containment tubes 15 are mounted in pairs at a center to center distance equal to and in alignment with the average spread distance of the three-point-hitch implement lift arms 14 below. The mounting bar 7 is in turn attached to suitably strong attachment points on the tractor, which is often the back of the tractor safety canopy or the mounting points for the safety rollbar. The paired containment tubes 15 and funnel bottoms 5 are preferably welded to the mounting bar 7 so that they are solidly vertical when the tractor is parked on a level surface, although they could still be functional if mounted out of the vertical plane or mounted on pivots so that they can change their alignment. Inside each containment tube 15 is a compression spring 4 which has a tensioning rod 6 running down through the middle, down through the tube bottom 5 through a hole in the mounting bar 7, through the lower tensioning nut 17, and terminating where the upper end of the lift chain 11 is attached to an adjustable shackle 8 that is threaded on to lower end of the tensioning rod 6. The upper end of the tensioning rod 6 also has an upper tensioning nut 2 and retention washer 3 which restrains the upper movement of the compression spring 4 and can be adjusted to change lift force and lift height. The lift chain 11 extending downward from the bottom of each tensioning rod 6 connects to each implement lift arm 12 directly below.

### Alternative Designs

A compression spring 4 effect and tensioning can be accomplished with air bladder springs or resilient shock absorbers that take the place of compression springs 4. With an air bladder system, heavy air bags, much like those used on heavy truck suspensions, take the place of the containment tubes 15 and compression springs 4. Tension and lift height is adjusted by the amount of air and air pressure within the bags. Lift is transferred to the lift chains 11 below by a saddle frame over the top of each air bag with multiple rods, housing or the like running down the sides then converging or connecting to a plate to which the top of each lift chain 11 is attached. Alternatively, a resilient shock absorber material, such as a rubber-like elastomer, can be substituted for a compression spring 4, leaving all other components essentially unchanged.

### Method of Operation

The implement is attached to the tractor's three-point-hitch, in conventional fashion, then the three-point-hitch and attached implement are raised by the three-point-hitch hydraulics and by the assistance of a jack or other means if the implement is too heavy for the hydraulics. When the implement and three-point-hitch are fully raised, the lower shackle 14 at the bottom end of each lift chain 11 is attached to the three-point-hitch implement lift arm 12. If the bottom end of the lift chain 11 will not reach the three-point-hitch implement lift arm 12, the lower tensioning nut 17 is adjusted up thus increasing the tension on the compression spring 4 while extending the bottom of the tensioning rod 6 and the lift chain 11 downward. If threading up the lower tensioning nut 17 is not sufficient to drop the lower end of the lifting chain far enough down to reach the three-point-hitch implement lift arm 12 without too great an increase in compression spring 4 tension then the tube cap 1 on the containment tube 15 is removed and the upper tensioning nut 2 is adjusted up to release tension on the compression spring 4. Once the lift chain 11 is attached to the three-point-hitch implement lift arm 12, and keeping the three-point-hitch and the implement in the fully raised position, the bottom the lower tensioning nut 17 and if necessary the top upper tensioning nut 2 are adjusted until the lift chain 11 becomes taught and the compression spring 4 is under slight tension. The three-point-hitch and implement are then lowered to the ground and checked for the proper degree of float (the amount of pressure the implement puts on the ground when the tractor is parked on the level). To lighten the float weight of the implement, the upper tensioning nut 2 is adjusted down, thus increasing the tension on the compression spring 4. With the implement attached and the lift assist system adjusted to the desired float, the hydraulic lift of the three-point-hitch is operated in normal fashion. However, much less operator attention is required since the implement automatically seeks the proper float height when lowered and smoothly follows along the contours of the ground with minimal drag.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A lift and float assist system for tractor three-point-hitches for supplementing the lifting force of a tractor three-point-hitch and reducing the ground bearing pressure of attached implements, comprising:
means for providing supplemental lift and implement floating;
means for containing the compression spring and shielding against accidental contact, cylindrically enclosing said means for providing supplemental lift and implement floating;
means for keeping contamination out of the containment tube and preventing injury, removably attached to said means for containing the compression spring and shielding against accidental contact;
means for supporting the compression springs and containment tubes;
means for tensioning the compression spring and adjusting the lift of the three-point-hitch, dynamically encircled by said means for providing supplemental lift and implement floating;
means for setting the tension of the compression spring, adjustably threaded to said means for tensioning the compression spring and adjusting the lift of the three-point-hitch;
means for retaining the upper end of the compression spring, adjacently assembled to said means for setting the tension of the compression spring;
means for setting the tension of the compression spring and adjusting of lift and float, adjustably threaded to said means for tensioning the compression spring and adjusting the lift of the three-point-hitch;
means for attaching the upper end of the lift chain and adjusting degree of lift and float, adjustably threaded to said means for tensioning the compression spring and adjusting the lift of the three-point-hitch;
means for transferring lift from the compression spring and tensioning rod to the tractor's implement lift arm, flexibly connected to said means for attaching the upper end of the lift chain and adjusting degree of lift and float;
means for connecting the lower end of the lift chain to the implement lift arm, flexibly attached to said means for transferring lift from the compression spring and tensioning rod to the tractor's implement lift arm; and
means for connecting to and lifting the implement and attaching it to the tractor, hingeably attached to said means for connecting the lower end of the lift chain to the implement lift arm.

2. The lift and float assist system for tractor three-point-hitches in accordance with claim 1, wherein said means for providing supplemental lift and implement floating comprises a compression spring.

3. The lift and float assist system for tractor three-point-hitches in accordance with claim 1, wherein said means for containing the compression spring and shielding against accidental contact comprises a cylindrical containment tube.

4. The lift and float assist system for tractor three-point-hitches in accordance with claim 1, wherein said means for keeping contamination out of the containment tube and preventing injury comprises a covering tube cap.

5. The lift and float assist system for tractor three-point-hitches in accordance with claim 1, wherein said means for supporting the compression springs and containment tubes comprises a rigid mounting bar attached to tractor.

6. The lift and float assist system for tractor three-point-hitches in accordance with claim 1, wherein said means for tensioning the compression spring and adjusting the lift of the three-point-hitch comprises a threaded tensioning rod.

7. The lift and float assist system for tractor three-point-hitches in accordance with claim 1, wherein said means for setting the tension of the compression spring comprises a threaded, adjustable upper tensioning nut.

8. The lift and float assist system for tractor three-point-hitches in accordance with claim 1, wherein said means for retaining the upper end of the compression spring comprises a rigid retention washer.

9. The lift and float assist system for tractor three-point-hitches in accordance with claim 1, wherein said means for setting the tension of the compression spring and adjusting of lift and float comprises an adjustable, threaded lower tensioning nut.

10. The lift and float assist system for tractor three-point-hitches in accordance with claim 1, wherein said means for attaching the upper end of the lift chain and adjusting degree of lift and float comprises a threaded adjustable shackle.

11. The lift and float assist system for tractor three-point-hitches in accordance with claim 1, wherein said means for transferring lift from the compression spring and tensioning rod to the tractor's implement lift arm comprises a lift chain.

12. The lift and float assist system for tractor three-point-hitches in accordance with claim 1, wherein said means for connecting the lower end of the lift chain to the implement lift arm comprises a lower shackle.

13. A lift and float assist system for tractor three-point-hitches for supplementing the lifting force of a tractor three-point-hitch and reducing the ground bearing pressure of attached implements, comprising:
a compression spring, for providing supplemental lift and implement floating;
a cylindrical containment tube, for containing the compression spring and shielding against accidental contact, cylindrically enclosing said compression spring;
a covering tube cap, for keeping contamination out of the containment tube and preventing injury, removably attached to said containment tube;
a rigid mounting bar attached to tractor, for supporting the compression springs and containment tubes;
a threaded tensioning rod, for tensioning the compression spring and adjusting the lift of the three-point-hitch, dynamically encircled by said compression spring;
a threaded, adjustable upper tensioning nut, for setting the tension of the compression spring, adjustably threaded to said tensioning rod;
a rigid retention washer, for retaining the upper end of the compression spring, adjacently assembled to said upper tensioning nut;
an adjustable, threaded lower tensioning nut, for setting the tension of the compression spring and adjusting of lift and float, adjustably threaded to said tensioning rod;
a threaded adjustable shackle, for attaching the upper end of the lift chain and adjusting degree of lift and float, adjustably threaded to said tensioning rod;
a lift chain, for transferring lift from the compression spring and tensioning rod to the tractor's implement lift arm, flexibly connected to said adjustable shackle;
a lower shackle, for connecting the lower end of the lift chain to the implement lift arm, flexibly attached to said lift chain; and
a rigid implement lift arm, for connecting to and lifting the implement and attaching it to the tractor, hingeably attached to said lower shackle.

14. The lift and float assist system for tractor three-point-hitches as recited in claim 13, further comprising:
a tube bottom, for retaining the bottom of the compression spring and aligning the tensioning rod, rigidly attached to said containment tube, and rigidly attached to said mounting bar.

15. The lift and float assist system for tractor three-point-hitches as recited in claim 14, wherein said tube bottom has characteristics selected from the following group: funnel shaped, and steel.

16. A lift and float assist system for tractor three-point-hitches for supplementing the lifting force of a tractor three-point-hitch and reducing the ground bearing pressure of attached implements, comprising:
a steel, enclosed compression spring, for providing supplemental lift and implement floating;
a steel, vertical, cylindrical containment tube, for containing the compression spring and shielding against accidental contact, cylindrically enclosing said compression spring;
a covering tube cap, for keeping contamination out of the containment tube and preventing injury, removably attached to said containment tube;
a funnel shaped, steel tube bottom, for retaining the bottom of the compression spring and aligning the tensioning rod, rigidly attached to said containment tube;
a steel, rigid, L-shapped, mounting bar attached to tractor, for supporting the compression springs and containment tubes, rigidly attached to said tube bottom;
a threaded, steel tensioning rod, for tensioning the compression spring and adjusting the lift of the three-point-hitch, dynamically encircled by said compression spring;
a steel, threaded, adjustable upper tensioning nut, for setting the tension of the compression spring, adjustably threaded to said tensioning rod;
a flat, rigid, steel, round retention washer, for retaining the upper end of the compression spring, adjacently assembled to said upper tensioning nut;
a steel, adjustable, threaded lower tensioning nut, for setting the tension of the compression spring and adjusting of lift and float, adjustably threaded to said tensioning rod;
a threaded, steel adjustable shackle, for attaching the upper end of the lift chain and adjusting degree of lift and float, adjustably threaded to said tensioning rod;
a flexible, steel lift chain, for transferring lift from the compression spring and tensioning rod to the tractor's implement lift arm, flexibly connected to said adjustable shackle;
a steel lower shackle, for connecting the lower end of the lift chain to the implement lift arm, flexibly attached to said lift chain; and
a rigid, steel implement lift arm, for connecting to and lifting the implement and attaching it to the tractor, hingeably attached to said lower shackle.
